(19) United States
(12) Patent Application Publication
(10) Pub. No.: US 2025/0269553 A1
(43) Pub. Date: Aug. 28, 2025

(54) WC-CO POWDER FOR ADDITIVE MANUFACTURING

(71) Applicant: Kennametal Inc., Latrobe, PA (US)

(72) Inventors: Zhuqing Wang, Greensburg, PA (US); Matthew Bonidie, Murrysville, PA (US); Gabriel Collins, Huntsville, AL (US)

(21) Appl. No.: 19/207,110

(22) Filed: May 13, 2025

Related U.S. Application Data
(63) Continuation-in-part of application No. 18/102,448, filed on Jan. 27, 2023.

(51) Int. Cl. B28B 1/00; B33Y 10/00; B33Y 80/00; C22C 29/06; C22C 29/08

(52) U.S. Cl. CPC B28B 1/001; B33Y 10/00; B33Y 80/00; C22C 29/067; C22C 29/08

(57) ABSTRACT

Disclosed herein are powder compositions that may be used for additive manufacturing comprising cemented carbide particles having controlled particle sizes and distributions. Also disclosed are methods of making such powder compositions and using such powder compositions for additive manufacturing. The single sintering process may eliminate the need for complex multiple high-temperature thermal treatments when producing the cemented carbide particles.

### CROSS-REFERENCE TO RELATED APPLICATION

This application is a continuation-in-part of U.S. patent application Ser. No. 18/102,448 filed Jan. 27, 2023, which is incorporated herein by reference.

### FIELD OF THE INVENTION

The present invention relates to sintered cemented carbide powder compositions that may be used in additive manufacturing, and sintered cemented carbide bodies additively manufactured with the sintered cemented carbide powder compositions.

### BACKGROUND INFORMATION

Additive manufacturing offers an efficient and cost-effective alternative to traditional article fabrication techniques based on molding processes. With additive manufacturing, the significant time and expense of mold and/or die construction and other tooling can be obviated. Further, additive manufacturing techniques make an efficient use of materials by permitting recycling in the process. Most importantly, additive manufacturing enables significant freedom in article design. Articles having highly complex shapes can be produced without significant expense allowing the development and evaluation of a series of article designs prior to final design selection.

### SUMMARY OF THE INVENTION

Disclosed herein are powder compositions comprising single cemented carbide particles having particular particle sizes and particle distributions. The single sintered cemented carbide particles comprise a metallic binder in an amount of 8 to 15 weight percent based on total weight of the single sintered cemented carbide particles. The single sintered cemented carbide particles also have an average individual porosity of no more than 5 volume percent. Also disclosed are methods of making the disclosed powder compositions that comprise a single sintering step. The single sintering process may eliminate the need for complex multiple high-temperature thermal treatments when producing the cemented carbide particles.

Disclosed herein is a powder composition for additive manufacturing comprising single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent.

Also disclosed herein is a method of making any of the powder compositions disclosed herein comprising milling the carbide particles and metallic binder, a polymeric binder, and a solvent to form a slurry; spray drying the slurry to form a powder; sintering the powder; and deagglomerating the powder to thereby form the powder composition comprising the single sintered cemented carbide particles.

Also disclosed herein is a method of making a powder composition for additive manufacturing comprising spray drying a slurry of metal carbide particles and a metallic binder to form a powder; sintering the powder; and deagglomerating the powder to thereby form the powder composition comprising single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent.

Also disclosed herein is an additively manufactured sintered cemented carbide body comprising: single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent; and an additive manufacturing binder.

Also disclosed herein is a method of forming any of the additive manufactured sintered cemented carbide bodies disclosed herein comprising binder jet printing a powder composition comprising the single sintered cemented carbide particles to form a green body; and sintering the green body to produce the sintered cemented carbide body.

Also disclosed herein is a method of forming a sintered cemented carbide body comprising additively manufacturing a green body comprising a powder composition and an additive manufacturing binder, wherein the powder composition comprises single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent; and sintering the green body to provide the sintered cemented carbide body.

### BRIEF DESCRIPTION OF THE DRAWINGS

FIG. 1 is a scanning electron microscopy (SEM) image of a cross section of the GU1 powder

FIG. 2 is an SEM image of a cross section of the GU2 powder.

FIG. 3A is an etched microstructure of a sintered sample 3D-printed from the GU1 powder.

FIG. 3B is an etched microstructure of a sintered sample 3D-printed from the GU2 powder.

### DETAILED DESCRIPTION

The invention disclosed herein is directed to powder compositions that may be used for additive manufacturing comprising single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent.

The powder composition may be used in any suitable additive manufacturing technique to form a three-dimensional part. The term “additive manufacturing technique” refers to processes for forming a three-dimensional object by successively adding material to the object layer by layer. The layer-by-layer, stratified construction makes it possible to easily form undercuts and complex geometrical structures, which, with previous conventional manufacturing methods, was not possible or required considerable effort and expense. The three-dimensional object may be based upon a 3D model of the component object that may be electronically designed as an electronic file having the design parameters. Additive manufacturing may also be referred to as 3D printing. The additive manufacturing technique of the invention comprises a process for forming a ceramic powder into the sintered cemented carbide body.

The additive manufacturing process may comprise, for example, binder jetting. As used herein, “binder jetting” or “binder jet” refers to the following method of producing a component: selectively jetting droplets of liquid binder onto a bed of powder (e.g., a ceramic powder) based on a 3D model of a component, adhering particles into a cross-section, depositing additional powder then binder to form the next layer of the object and repeating this process until the green component is finished. For example, the binder jetting apparatus spreads a layer of the metal, ceramic, or cermet powder in a build box, a printhead moves over the powder layer depositing liquid binder according to design parameters for that layer, the layer is dried, the build box is lowered, a new layer of ceramic powder is spread, and the process is repeated until the green article (body) is completed. Although binder jetting is primarily described herein as the additive manufacturing process for making the present materials, other types of additive processes may be adapted for use herein.

Sintered cemented carbide particles of the powder composition each comprise individual metal carbide grains sintered and bound together by a metallic binder. The sintered cemented carbide particles may have a substantially spherical shape. As used herein, “spherical” means that the particles are generally sphere-shaped, having convexly curved outer surfaces with substantially no flat or concave surface areas, and an aspect ratio of 1:1.

The powder compositions disclosed herein demonstrate a monomodal distribution. As used herein, with reference to a powder composition, a “monomodal distribution” means that a frequency distribution curve of particle size of the powder has a single peak instead of multiple peaks. Powder size distributions described and claimed herein may be measured using a laser diffraction particle size analyzer (S-3500, commercially available from Microtrac MRB).

The cemented carbide particles may be produced by a single sintering process. As used herein, with reference to the cemented carbide particles, the terms “single sintered” and “single sintering” mean that the cemented carbide particles are not subjected to a second sintering process during their production. For example, there is no subsequent sintering step after the initial sintering step and prior to formation of the final cemented carbide particles or other high temperature step that affects the initially sintered cemented carbide particles such as plasma spheroidization. Although the single sintered cemented carbide particles may be subjected to subsequent processing such as deagglomeration and/or sieving to produce the present powder compositions, the particles are not subjected to subsequent sintering or other high-temperature treatments.

The sintered cemented carbide particles of the powder composition may have a D50 of from greater than 10 μm, such as at least 10.5 μm such as at least 11 μm, such as at least 12 μm, such as at least 13 μm, such as at least 14 μm. The sintered cemented carbide particles of the powder composition may have a D50 of no more than 20 μm, such as no more than 19 μm, such as no more than 18 μm, such as no more than 16 μm. The sintered cemented carbide particles of the powder composition may have a D50 of from greater than 10 μm to 20 μm, such as from 11 μm to 19 μm, such as from 12 μm to 18 μm, such as from 13 μm to 19 μm, such as from 14 μm to 18 μm, such as from 14 μm to 16 μm. As used herein, “D50” means the point in the size distribution in which 50 percent or more of the total volume of material in the sample is contained. For example, a D50 of 13 μm means that 50 percent of the particles of the sample have a size smaller than 13 μm.

The sintered cemented carbide particles of the powder composition may have a D10 of at least 5 μm, such as at least 6 μm, such as at least 7 μm. The sintered cemented carbide particles of the powder composition may have a D10 of no more than 10 μm, such as no more than 9 μm. The sintered cemented carbide particles of the powder composition may have a D10 of from 5 μm to 10 μm, such as from 6 μm to 9 μm, such as from 7 μm to 9 μm. As used herein, “D10” means the point in the size distribution in which 10 percent or more of the total volume of material in the sample is contained. For example, a D10 of 5 μm means that 10 percent of the particles of the sample have a size of 5 μm or smaller.

The sintered cemented carbide particles of the powder composition may have a D90 of at least 15 μm, such as at least 18 μm, such as at least 20 μm. The sintered cemented carbide particles of the powder composition may have a D90 of no more than 50 μm, such as no more than 45 μm, such as no more than 30 μm, such as no more than 27 μm. The sintered cemented carbide particles of the powder composition may have a D90 of from 15 μm to 50 μm, such as from 15 μm to 45 μm, such as from 18 μm to 30 μm, such as from 20 μm to 27 μm. As used herein, “D90” means the point in the size distribution in which 90 percent or more of the total volume of material in the sample is contained. For example, a D90 of 29 μm means that 90 percent of the particles of the sample have a size smaller than 29 μm.

The sintered cemented carbide particles comprise one or more metal carbides. The metal carbides may comprise Group IVB metal carbides, Group VB metal carbides, Group VIB metal carbides, or combinations thereof. For example, the sintered cemented carbide particles may comprise tungsten carbide, chromium carbide, titanium carbide, vanadium carbide, tantalum carbide, niobium carbide, zirconium carbide, and/or hafnium carbide. The sintered cemented carbide particles may comprise tungsten carbide and a second metal carbide. The tungsten carbide may be present in an amount of at least 80 weight percent based on total weight of the sintered cemented carbide particles, such as from 80 to 85 weight percent. If present, the second metal carbide may be present in an amount of from 0.1 to 5 weight percent based on total weight of the sintered cemented carbide particles.

The sintered cemented carbide particles may not comprise multiple metal and/or non-stoichiometric metal carbides. Double and/or lower metal carbides include but are not limited to, eta phase (Co₃W₃C or Co₆W₆C), W₂C, and/or W₃C. Additionally, the sintered cemented carbide particles may exhibit uniform or substantially uniform microstructure.

As previously stated, the sintered cemented carbide particles comprise a metallic binder. The metallic binder may comprise cobalt, cobalt alloys, nickel, nickel alloys, iron, iron alloys, tungsten, or a combination thereof.

The metallic binder may further comprise a grain growth inhibitor and/or other additives, such as noble metal additives, and/or silicon. Examples of suitable grain growth inhibitors include chromium, vanadium, tantalum, titanium, niobium, molybdenum, ruthenium, and/or zirconium. Examples of suitable noble metal additives include platinum, palladium, rhenium, rhodium, and/or alloys thereof. Other additives include molybdenum, silicon, or combinations thereof. If present, additives may be present in an amount of from 0.1 to 10 weight percent based on total weight of the metallic binder.

The metallic binder may be present in the sintered cemented carbide particles in an amount of at least 8 weight percent based on total weight of the sintered cemented carbide particles, such as 9 weight percent, such as 9.5 weight percent. The metallic binder may be present in the sintered cemented carbide particles in an amount of no more than 15 weight percent based on total weight of the sintered cemented carbide particles, such as no more than 12 weight percent, such as no more than 11 weight percent. The metallic binder may be present in the sintered cemented carbide particles in an amount of from 8 to 15 weight percent based on total weight of the sintered cemented carbide particles, such as from 9 to 12 weight percent, such as from 9.5 to 11 weight percent. The metallic binder may be present in the sintered cemented carbide particles in an amount of 10 weight percent based on total weight of the sintered cemented carbide particles.

The sintered cemented carbide particles may have an average individual porosity of at least 0.5 volume percent, such as at least 1 volume percent. The sintered cemented carbide particles may have an average individual porosity of no more than 5 volume percent, such as no more than 4 volume percent, such as no more than 3 volume percent. The sintered cemented carbide particles may have an average individual porosity of from 0.5 to 5 volume percent, such as from 0.5 to 4 volume percent, such as from 1 to 3 volume percent. As used herein, “individual particle porosity” refers to the volume percent of pores in an individual particle based upon the total volume of the particle. That is, if an individual particle has a particle porosity of 5 volume percent, 95 volume percent of the particle comprises material, such as, for example, metal carbides and/or metallic binder.

The powder composition may have an apparent density of at least 3.0 g/cm³, such as at least 3.5 g/cm³, such as at least 4.0 g/cm³. The powder composition may have an apparent density of no more than 7.0 g/cm³, such as no more than 6.5 g/cm³, such as no more than 6.0 g/cm³. The powder composition may have an apparent density of from 3.0 g/cm³ to 7.0 g/cm³, such as from 3.5 g/cm³ to 6.5 g/cm³, such as from 4.0 g/cm³ to 6.0 g/cm³. As used herein, “apparent density” means the mass of a unit volume of powder or particles in the loose condition. Apparent density may also be called bulk density. Apparent density can be determined according to ASTM B212 Standard Test Method for Apparent Density of Free-Flowing Metal Powders using the Hall Flowmeter Funnel.

The powder composition may have a tap density of at least 4.0 g/cm³, such as at least 5.0 g/cm³, such as at least 6.0 g/cm³. The powder composition may have a tap density of no more than 8.5 g/cm³, such as no more than 8.0 g/cm³, such as no more than 7.5 g/cm³. The powder composition may have a tap density of from 4.0 g/cm³ to 8.5 g/cm³, such as from 5.0 g/cm³ to 8.0 g/cm³, such as from 6.0 g/cm³ to 7.5 g/cm³. As used herein, “tap density” means the mass of a unit volume of powder once the powder has been tapped for a defined number of taps. Tap density can be determined according to ASTM B527 Standard Test Method for Tap Density of Metal Powders and Compounds.

The ratio of the tap density to the apparent density (Hausner ratio) of the powder composition may be at least 1.10, such as at least 1.15, such as at least 1.20. The Hausner ratio of the powder composition may be no more than 1.45, such as no more than 1.40, such as no more than 1.35. The Hausner ratio of the powder composition may be from 1.10 to 1.45, such as from 1.15 to 1.40, such as 1.20 to 1.35.

The present invention is further directed to a method of making one of the powder compositions disclosed herein comprising milling the cemented carbide particles with the metallic binder, a polymeric binder, and a solvent to form a mixture; spray drying the mixture to form a powder; sintering the powder; and deagglomerating the powder to thereby form the powder composition comprising the single sintered cemented carbide particles.

It was surprisingly discovered that the densities and individual particle porosities of the powder compositions disclosed herein can be achieved through one sintering process administered to the particles. The methods of forming the powder compositions disclosed herein may not have a second sinter step. The sintering processes may not employ sintering inhibitor(s) to mitigate particle stick or adhesion. Sintered cemented carbide particle properties described herein can be achieved in the absence of sintering inhibitor(s). Sintered cemented carbide particles may be prepared by sintering a grade powder composition at temperatures of at least 1100° C., such as at least 1200° C., such as at least 1240° C., such as from 1200° C. to 1350° C., such as from 1240° C. to 1325° C. for 1.5 to 3 hours to provide a sintered mass. The sintered cemented carbide particles are typically agglomerated and are subsequently deagglomerated by methods such as milling and the like to provide individual sintered cemented carbide particles. The deagglomerated particles may then be sieved to provide the desired particle sizes and distributions.

The present invention is also directed to an additively manufactured sintered cemented carbide body comprising single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent.

When the carbide comprises tungsten carbide and the metallic binder comprises cobalt, the sintered cemented carbide body may have a sintered density of at least 13.8 g/cm³, such as at least 13.9 g/cm³, such as at least 14.0 g/cm³. The sintered density may be measured by ASTM B311 Density Determination for Powder Metallurgy Materials.

The sintered cemented carbide body may have a sinter porosity rating of A08B04C02 or better, for example, for wear applications, For high performance applications, the sintered cemented carbide body may have a sinter porosity rating of A04B00C00 or better, such as A02B00C00, such as A00B00C00, as determined by the procedures according to ASTM B276: Standard Test Method for Apparent Porosity in Cemented Carbides Active Only.

The sintered cemented carbide body may have a uniform microstructure.

A microstructure of the sintered cemented carbide body may exhibit an average tungsten carbide grain size of at least 0.3 μm, such as at least 0.4 μm, such as at least 0.5 μm. A microstructure of the sintered cemented carbide body may exhibit an average tungsten carbide grain size of no more than 0.8 μm, such as no more than 0.7 μm, such as no more than 0.6 μm. A microstructure of the sintered cemented carbide body may exhibit an average tungsten carbide grain size of from 0.3 μm to 0.8 μm, such as from 0.4 μm to 0.7 μm, such as from 0.5 μm to 0.6 μm.

At least 70%, such as at least 75%, such as at least 80% of all the tungsten carbide grains in a microstructure of the sintered cemented carbide body may have a grain size of at least 0.1 μm, such as at least 0.2 μm, such as less than 1 μm, such as no more than 0.8 μm. At least 70%, such as at least 75%, such as at least 80% of all the tungsten carbide grains in a microstructure of the sintered cemented carbide body may have a grain size of from 0.1 μm to less than 1 μm, such as from 0.2 μm to 0.8 μm.

At least 90%, such as at least 95%, such as at least 99% of all the tungsten carbide grains in a microstructure of the sintered cemented carbide body may have a grain size of less than 2 μm, such as no more than 1.9 μm, such as no more than 1.8 μm.

The present invention is further directed to a method of forming a sintered cemented carbide body comprising: additively manufacturing a green body comprising a powder composition and an additive manufacturing binder, wherein the powder composition comprises single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent; and sintering the green body to provide the sintered cemented carbide body. Any of the powder compositions disclosed herein above may be used to form the sintered cemented carbide body.

A green body is formed by additively manufacturing one of the powder compositions described herein and an additive manufacturing binder. Any organic binder known in the art may be used as the additive manufacturing binder. In examples, the organic binder may comprise one or more polymeric materials, such as polyvinylpyrrolidone (PVP), polyethylene glycol (PEG), or mixtures thereof. The organic binder may be curable, which can enhance the strength of the green article. The polymeric binder may be an aqueous binder or a solvent binder. The green articles may exhibit a binder saturation of at least 80%, such as 100%, or greater than 100%.

The green body may then be sintered under conditions and for time periods adequate to provide sintered bodies having the desired density. The green article can be vacuum sintered or sintered under a hydrogen or argon atmosphere at temperatures of 1300° C. to 1560° C. Moreover, sintering times can generally range from 10 minutes to 5 hours. Hot isostatic pressing (HIP) may optionally be added to the sintering process. HIP may be administered as a post-sinter operation or during vacuum sintering. Hot isostatic pressing can be administered for up to 2 hours at pressures of 1 MPa to 300 MPa and temperatures of 1300° C. to 1560° C.

The sintered cemented carbide bodies may exhibit a volume shrinkage in the sintered samples compared to as-printed samples of at least 15 volume percent, such as at least 20 volume percent, such as no more than 40 volume percent, such as no more than 30 volume percent. The sintered cemented carbide bodies may exhibit a volume shrinkage in the sintered samples compared to the green bodies of from 15 to 40 volume percent, such as from 20 to 30 volume percent.

Sintered cemented carbide bodies produced according to the methods described herein can be employed in a variety of industries including petrochemical, automotive, aerospace, industrial tooling, metal cutting tools, and manufacturing. The sintered cemented carbide bodies may be used as components exposed to wear environments or abrasive operative conditions such as flow control components, pumps, bearings, valves, valve components, centrifuge components, disk stacks, and/or fluid handling components. The sintered cemented carbide body can also comprise one or more internal fluid flow channels formed by the additive manufacturing technique. The sintered cemented carbide body may be near-net shape and/or require minimal post sintering processing to place the bodies in final form.

### Examples

### Production of Spherical Powders GU1 and GU2

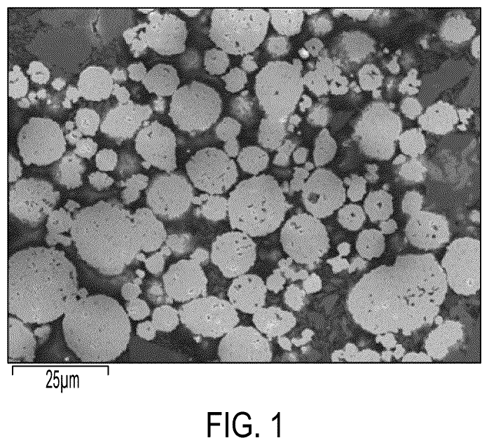

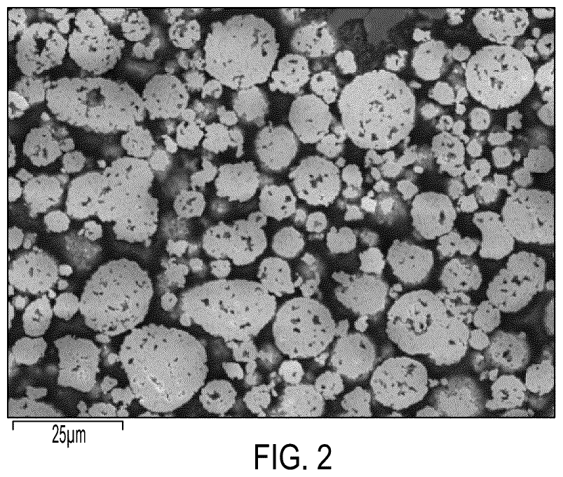

A mixture of 90% by weight tungsten carbide (WC) particles, 10% by weight cobalt (Co) powder, and organic additives were milled to produce a slurry. The slurry was then spray-dried and sintered in vacuum (<10⁻¹ torr) in the solid state at 1250° C. to 1300° C. for 1 to 2 hours, forming a single sintered powder. The sintered powder was deagglomerated by milling and sieved to reach the desired powder size distribution. Scanning electron microscopy (SEM) images of cross sections of the GU1 and GU2 powders are provided in FIGS. 1 and 2, respectively. Table 1 provides the powder size distribution (D10, D50, and D90), porosity, and shape of the GU1 and GU2 powders. The powder size distributions were measured using laser scattering method, Micro-trac. To determine porosity and morphology, the powder samples were mounted, polished, and imaged. Image J, an image processing software, was applied to the SEM image to determine porosity.

TABLE 1
Properties of powder compositions

| | | | | | Apparent | Tap | | |
|---|---|---|---|---|---|---|---|---|
| | Co | D10 | D50 | D90 | density | density | Porosity | |
| Powder | (wt. %) | (μm) | (μm) | (μm) | (g/cm³) | (g/cm³) | (%) | Shape |
| C1 | 10.0 | 8.0 | 14.8 | 22.8 | 5.3 | 6.9 | 1.2 | Spherical |
| C2 | 10.0 | 8.1 | 15.3 | 22.5 | 5.4 | 6.9 | 2.7 | Spherical |

Test coupons with dimensions of 10 mm×10 mm×7 mm were 3D-printed from each of the GU1 and GU2 powders using a binder jetting machine (GE H₂) with a water-based additive manufacturing binder (Rapid Wick, binder droplet size approximately 10 pL). The layer thickness was 50 μm and the average additive manufacturing binder saturation was in the range of 60% to 100%. The green density was 40% to 43% of theoretical density. The green density was measured by measuring the mass and dimension of a green body cube.

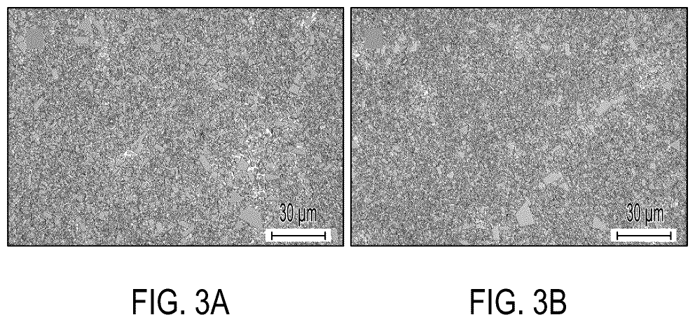

The test coupons were cured at 195° C. for 4 hours in a curing oven in nitrogen atmosphere. After curing, the test coupons were depowdered by removing the surrounding unbounded powder using a vacuum. Samples were then put on graphite trays coated with a graphite-based parting agent for debinding, then sintered in a sinter-HIP furnace. Then, the samples were debound by heating up to 350° C. to 550° C. in hydrogen atmosphere. Samples were then sintered at 1450° C. to 1550° C. and a pressure of 3.4 MPa to 5.5 MPa in argon atmosphere. The sintered samples exhibited a shrinkage of 20% to 30% volume from the as-printed samples. The sintered samples were mounted, polished, and etched to check the microstructure. The sintered samples had a density of 14.4 g/cm³ as measured by Archimedes measurement and a porosity rating of A02B00C00 or lower, measured according to ASTM B276. Results are provided in Table 2. FIGS. 3A and 3B show the etched microstructures of the sintered samples of GU1 and GU2 powders, respectively.

MIPAR software was used to analyze the grain size of five optical images of each sintered sample. Both GU1 and GU2 powders exhibited an average grain size of 0.5 μm to 0.6 μm. The grain size distributions were then characterized for their uniformity. Both GU1 and GU2 powders exhibited 80% or more of all grains having sizes of 0.2 μm to 0.8 μm, and 99% of all grains had sizes less than 1.8 μm.

TABLE 2

| | | Binder | Green | Sintered | |
|---|---|---|---|---|---|
| | | saturation | density | density | |
| Sample | Powder | (%) | (g/cm³) | (g/cm³) | Porosity |
| 1 | GU1 | 80 | 6.05 | 14.40 | (A00)A02B00C00 |
| 2 | GU2 | 80 | 5.90 | 14.40 | (A00)A02B00C00 |

For purposes of this detailed description, it is to be understood that the invention may assume various alternatives and step sequences, except where expressly specified to the contrary. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters set forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “from 1 to 10” is intended to include all sub-ranges between (and including) the recited minimum value of 1 and the recited maximum value of 10, that is, having a minimum value equal to or greater than 1 and a maximum value equal to or less than 10.

As used herein, “including,” “containing,” and like terms are understood in the context of this application to be synonymous with “comprising” and are therefore open-ended and do not exclude the presence of additional undescribed or unrecited elements, materials, ingredients, or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described.

In addition, in this application, the use of “or” means “and/or” unless specifically stated otherwise, even though “and/or” may be explicitly used in certain instances.

Whereas specific aspects of the inventions have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention, which is to be given the full breadth of the claims appended and any and all equivalents thereof.

1. A powder composition for additive manufacturing comprising single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent.

2. The powder composition of claim 1, wherein the single sintered cemented carbide particles comprise a Group IVB metal carbide, a Group VB metal carbide, and/or a Group VIB metal carbide.

3. The powder composition of claim 1, wherein the metallic binder comprises cobalt, nickel, iron, and/or alloys thereof.

4. The powder composition of claim 1, wherein the single sintered cemented carbide particles comprise tungsten carbide and the metallic binder comprises cobalt.

5. The powder composition of claim 1, comprising from 9 to 12 weight percent of the metallic binder based on total weight of the sintered cemented carbide particles.

6. The powder composition of claim 1, wherein the D50 is from 11 μm to 19 μm.

7. The powder composition of claim 1, wherein the D10 is at least 7 μm.

8. The powder composition of claim 1, wherein the single sintered cemented carbide particles have a D90 of less than 50 μm.

9. The powder composition of claim 1, wherein the D90 is from 15 μm to 30 μm.

10. The powder composition of claim 1, wherein the single sintered cemented carbide particles are substantially spherical.

11. The powder composition of claim 1, wherein the metallic binder comprises an additive comprising platinum, palladium, rhenium, rhodium, ruthenium, molybdenum, and/or alloys thereof.

12. The powder composition of claim 1, wherein the powder composition has a tap density of from 4.0 g/cm³ to 8.5 g/cm³ as measured by ASTM B527.

13. The powder composition of claim 1, wherein the powder composition has an apparent density of from 3.0 g/cm³ to 7.0 g/cm³ as measured by ASTM B212.

14. A method of making the powder composition of claim 1 comprising:
milling the carbide particles, the metallic binder, a polymeric binder, and a solvent to form a slurry;
spray drying the slurry to form a powder;
sintering the powder; and
deagglomerating the powder to thereby form the powder composition comprising the single sintered cemented carbide particles.

15. A method of making a powder composition for additive manufacturing comprising:
spray drying a slurry of metal carbide particles and a metallic binder to form a slurry;
sintering the powder; and
deagglomerating the powder to thereby form the powder composition comprising single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent.

16. The method of claim 15, wherein the deagglomerating step comprises milling.

17. An additively manufactured sintered cemented carbide body comprising:
single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent; and
an additive manufacturing binder.

18. The additively manufactured sintered cemented carbide body of claim 17, wherein the sintered cemented carbide body comprises tungsten carbide and cobalt, and has a sintered density of at least 13.8 g/cm³.

19. The additively manufactured sintered cemented carbide body of claim 17, wherein the metallic binder comprises cobalt and the sintered cemented carbide body has a sintered density of at least 14.0 g/cm³.

20. The additively manufactured sintered cemented carbide body of claim 17, comprising from 8 to 15 weight percent of the metallic binder based on total weight of the single sintered cemented carbide body.

21. The additively manufactured sintered cemented carbide body of claim 17, wherein the single sintered cemented carbide particles have a D50 of from 11 μm to 19 μm.

22. The additively manufactured sintered cemented carbide body of claim 17, wherein the single sintered cemented carbide particles have a D10 of at least 7 μm.

23. The additively manufactured sintered cemented carbide body of claim 17, wherein the single sintered cemented carbide particles have a D90 of less than 50 μm.

24. The additively manufactured sintered cemented carbide body of claim 17, wherein the single sintered cemented carbide particles have a D90 of from 15 μm to 30 μm.

25. The additively manufactured sintered cemented carbide body of claim 17, wherein the sintered cemented carbide body has a sinter porosity rating of A04B00C00, A02B00C00, or A00B00C00, as determined by ASTM B276.

26. A method of forming the additively manufactured sintered cemented carbide body of claim 17 comprising:
binder jet printing a powder composition comprising the single sintered cemented carbide particles and the additive manufacturing binder to form a green body; and
sintering the green body to produce the sintered cemented carbide body.

27. A method of forming a sintered cemented carbide body comprising:
additively manufacturing a green body comprising a powder composition and an additive manufacturing binder, wherein the powder composition comprises single sintered cemented carbide particles having a D50 of from greater than 10 μm to 20 μm and a D10 of from 5 μm to 10 μm and comprising from 8 to 15 weight percent of a metallic binder based on total weight of the single sintered cemented carbide particles, wherein the single sintered cemented carbide particles have an average individual porosity of no more than 5 volume percent; and
sintering the green body to provide the sintered cemented carbide body.

28. The method of claim 27, wherein the additively manufacturing step comprises binder jet printing, and the additive manufacturing binder comprises a printing binder.
